(19) United States
(12) Patent Application Publication
(10) Pub. No.: US 2020/0234854 A1
(43) Pub. Date: Jul. 23, 2020

(54) CABLING APPARATUS FOR HIGH RESISTANCE APPLICATIONS

(71) Applicant: Kyzen Corporation, Nashville, TN (US)

(72) Inventor: Mark McMeen, Huntsville, AL (US)

(73) Assignee: Kyzen Corporation, Nashville, TN (US)

(21) Appl. No.: 16/731,389

(22) Filed: Dec. 31, 2019

Related U.S. Application Data
(60) Provisional application No. 62/795,336, filed on Jan. 22, 2019.

(51) Int. Cl. H01B 11/08; H01B 11/10; H01B 3/18; H01B 1/02

(52) U.S. Cl. CPC H01B 11/08; H01B 1/02; H01B 3/18; H01B 11/1091

(57) ABSTRACT

A telecommunications cable for making high resistance measurements comprising a plurality of bundles, each comprising a twisted pair of Category 6a copper conductors and a metal foil shield, one of said copper conductors in each twisted pair serving as a signal wire and the other of said copper conductors in each twisted pair being grounded to thereby serve as a noise ground; a braided grounded metal sheath surrounding said plurality of bundles of twisted pairs; and a grounded shield used as an outer sleeve, whereby said cable is triple grounded.

### CROSS-REFERENCE TO RELATED APPLICATION

This application claims the benefit of provisional application Ser. No. 62/795,336 filed Jan. 22, 2019, entitled Cabling Apparatus for High Resistance Applications, which is embodied herein by reference in its entirety.

### FIELD OF THE INVENTION

This invention relates to apparatus for electrical measurement.

### BACKGROUND

In the measurement of high resistances, it is normal to have to be able to measure low to extremely low currents, sometimes a few femto-amperes (fA) or even less, in order to not have to use excessive voltages, which may be harmful to electronics and their operators. At these low currents, one must have to take extensive precautions to minimize stray currents (noise) in order to make reliable measurements. This is because materials which are typically considered to be non-conductive have resistances of several hundred megaohms to a few gigaohms, and such can be considered to be nonconductive for ordinary applications. When one is measuring resistances much higher than this, the ammeter or electrometer (referred to hereafter as “meter”) must have a very high input resistance, generally greater than 100 teraohms (>100 TΩ). This results in an unfortunate side effect, namely that “the path of least resistance” for the current that is to be measured is everything but the desired signal path. This results in extreme isolation means being implemented to connect the device under test (DUT), and the meter. There are two main methods of connecting a DUT, for example a printed circuit board (PCB), undergoing a reliability test, such as Surface Insulation Resistance (SIR). The first method is to use a triaxial cable (“triax”), which is considered to be a “gold standard” for high resistance measurements. A triax cable consists of three different conductors per cable. A diagram of a typical triax cable is shown in FIG. 1. First there is the center conductor, which carries the low current signal. This is in the center of the cable. Next there is an insulation layer, which is typically polytetrafluoroethylene (PTFE). The next layer, the inner shield, is what makes the triaxial cable have the lowest leakage current and noise. This inner shield is held at the same potential (voltage), with respect to ground, as the signal by the meter. The purpose of this is that current can only flow between regions of different potential. As there is virtually no potential difference between the center conductor and the inner shield, no current flows through the insulator. Then there is another layer of insulation, again generally PTFE. Next is the outer shield, which is connected to ground. The purpose of this conductor is to prevent external sources of current from inducing current in the center conductor. Lastly there is another layer of insulation, the outer jacket.

The other commonly used solution to this problem is a ribbon cable or a multi-wire planar cable. If one uses a ribbon cable of the appropriate insulation type and quality, one can achieve a high enough resistance to allow for measurements of the low currents.

### BRIEF SUMMARY OF THE INVENTION

In the intended application of the apparatus, cables are connecting several DUTs. The apparatus of the present invention configures standard telecommunications cables which are readily available, inexpensive, shielded, and are reasonably easy to route in a proper manner. There are specific precautions that are needed to be taken to adapt them to use in a more demanding application than their intended use. The invention uses a pair of standard category 6a networking cables and a standard metal braided cable management sheath. This cabling apparatus allows for resistance measurements up to around 10 TΩ from readily accessible cable types.

### BRIEF DESCRIPTION OF THE DRAWINGS

FIG. 1 is a longitudinal cross-section of a typical triaxial cable; and

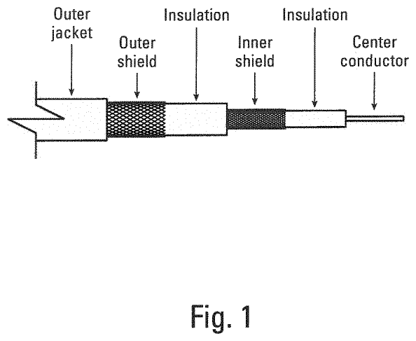

FIG. 2 is a transverse cross section of a cable assembly of the present invention.

### DETAILED DESCRIPTION OF THE INVENTION

The invention is a telecommunications cable for making high resistance measurements comprising a plurality of bundles, each comprising a twisted paid of category 6a copper conductors and a metal foil shield, one of said copper conductors in each twisted pair serving as a signal wire and the other of said copper conductors in each twisted pair being grounded to thereby serve as a noise ground; a braided grounded metal sheath surrounding said plurality of bundles of twisted pairs, and a grounded shield used as an outer sleeve, whereby said cable is triple grounded.

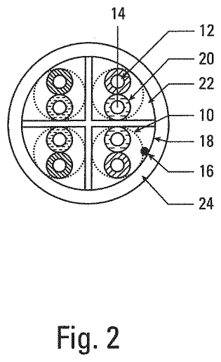

FIG. 2 shows a cable assembly comprising a plurality of Cat 6a twisted pair cables 10. When utilized in our present invention one wire 12 of each pair of wires in the twisted pair is utilized as a current signal. The other wire 14 in the pair is connected to the same ground potential as the meter. The Cat 6a standard has the pairs of wires twisted in such a way to minimize noise and crosstalk between the two. Each wire of the twisted pair 10 is surrounded by insulation 20. By grounding the other wire it serves essentially as a shield. The drain wire 16 which is connected to the aluminum foil shield 18 serves as a secondary shield and is connected to the meter ground as well. In order to get the appropriate low leakage current connection needed a second Cat 6a cable is used in the identical way. These two Cat 6a cables are then placed in a standard braided metal cable management sheath. This metal sheath is connected to the meter ground. In order to take measurements, such as SIR measurements where there are many measurements to be made, one of the two Cat 6a cables provides the positive voltage, and the other provides the negative. The meter can then switch between the appropriate pairs of wire. FIG. 2 shows a core 22 of four pairs cabled together. The cable is surrounded by a jacket 24. //The outer jacket or outer sleeve 24 is made of PTFE, nylon polyethylene, PVS, PET, PEEK, ABS, or polypropylene.

This configuration reduces alien crosstalk which is the interference caused by adjaent conductors in a cable. Alien crosstalk is a combination of two components: alien Near-End CrossTalk (NEXT) and alien Far End CrossTalk (FEXT). These are types of noise that gets capacitively coupled into the current signal. The amount of noise in these situations is proportional to the:

Inverse distance from each signal wire;

Length (technically impedance) of the wire;

Frequency;

### Amplitude.

The present cabling apparatus mitigates these by four main methods:

Shielding of the signal wire (provided by the aluminum foil shield in Cat 6a and many other telecommunications cables)

Separating the signal from the source. This is provided by using two Cat 6a cables;

Reducing the amplitude of the noise. This is achieved by grounding one conductor of each twisted pair. This provides a low impedance path for alien crosstalk to flow;

By using a twisted pair, the induced noise is canceled out as each wire's induced current induces a counter current in the other.

The foregoing description of the invention has been presented for purposes of illustration and description. It is not intended to be exhaustive or to limit the invention to the precise form disclosed, and other modifications and variations may be possible in light of the above teachings.

The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A telecommunications cable for making high resistance measurements comprising
a. a plurality of bundles, each comprising a twisted pair of Category 6a copper conductors and a metal foil shield, one of said copper conductors in each twisted pair serving as a signal wire and the other of said copper conductors in each twisted pair being grounded to thereby serve as a noise ground;
b. a braided grounded metal sheath surrounding said plurality of bundles of twisted pairs; and
c. an outer sleeve,
whereby said cable is triple grounded.

2. A telecommunications cable according to claim 1, in which each of said pairs of Category 6a conductors:
a. has one wire color strand of the twisted pair of wires for signal continuity and uses its unused matching pair of wire twisted of opposite color strand as its grounded shield,
b. uses the internal ground shield inside the category 6a wire bundle as an additional ground shield within the pair of category 6a wire bundles,
c. uses a braided sleeving as an additional shield to over sleeve the pair of category 6a wire bundles.

3. A telecommunications cable according to claim 2, in which each of the pairs of category 6a cable bundles has an outer sleeve.

4. A telecommunications able according to claim 3, wherein said outer sleeve is grounding and grounds the bundles

5. A telecommunications cable according to claim 4, wherein said outer sleeve comprises a conductive material.

6. A telecommunications cable according to claim 5, wherein said conductive material is copper, stainless steel, or aluminum.

7. A telecommunications cable according to claim 5, wherein said conductive material comprises a bus wire.

8. A telecommunications able according to claim 3, wherein said outer sleeve is non-grounding.

9. A telecommunications cable according to claim 8, wherein said outer sleeve comprises PTFE, nylon polyethylene, PVS, PET, PEEK, ABS, or polypropylene.

10. A telecommunications cable according to claim 1, comprising four of said bundles.
